(19) United States
(12) Patent Application Publication
(10) Pub. No.: US 2003/0112366 A1
(43) Pub. Date: Jun. 19, 2003

(54) Apparatus and methods for improving video quality delivered to a display device

(75) Inventors: David M. Baylon, San Marcos, CA (US); Joseph Diamand, Del Mar, CA (US); Rajeev Gandhi, San Diego, CA (US); Limin Wang, San Diego, CA (US); Ajay Luthra, San Diego, CA (US)

Correspondence Address: LAW OFFICE OF BARRY R LIPSITZ, 755 MAIN STREET, MONROE, CT, 06468, US

(73) Assignee: General Instrument Corporation, Horsham, PA (US)

(21) Appl. No.: 09/990,534

(22) Filed: Nov. 21, 2001

(51) Int. Cl. H04N 7/01

(52) U.S. Cl. 348/441

(57) ABSTRACT

Apparatus and methods are provided for improving the quality of streaming video delivered to a display device. A current video signal segment is encoded for subsequent decoding at the display device. As part of the encoding step, an estimate is made of the time required for decoding the video signal segment at the display device. If the estimated time exceeds a predetermined decoder time period, either (i) the current video signal segment is re-encoded such that it can be decoded within the decoder time period, or (ii) a subsequent video signal segment is encoded to enable decoding thereof without reference to the current segment.

### BACKGROUND OF THE INVENTION

The present invention relates to video encoding systems, and more particularly to apparatus and methods for improving the quality of video signals delivered to a display device, such as a television. Although not limited thereto, the invention is particularly advantageous for streaming video applications.

Broadcasting of digital audiovisual content has become increasingly popular in cable and satellite television networks, and is expected to gradually supplant the analog schemes used in such networks and in television broadcast networks. The delivery of digital audiovisual content over global computer networks, such as the Internet, is also increasing at a rapid pace. One delivery mechanism used to send audio and video content, particularly over the Internet is known as “streaming media,” in which files are buffered as they are received by a personal computer (PC) and played immediately once enough data has been buffered to provide a continuous presentation which is relatively unaffected by transmission errors and bottlenecks. Streaming media is played without having to be permanently downloaded to the PC, saving valuable storage space on, e.g., the user's hard drive.

A subset of streaming media is “streaming video,” which is analogous to one-way broadcast video in an Internet context. Streaming video uses a different, non-backwards compatible compression method than that specified by the Moving Picture Experts Group MPEG-2 standard. The compression techniques generally used with streaming video are more similar to those set forth in the MPEG-4 standard, which was designed to provide video in bandwidth constrained environments (e.g., narrowband telephone company networks). As a result of this, the quality of streaming video has typically been much lower than that provided by cable and satellite television systems. Thus, the use of streaming video has been largely dismissed by subscription television system operators. It is expected, however, that streaming video will soon become a reality for cable and satellite television. For example, two-way Internet Protocol (IP) paths are already being built into subscription television networks for, e.g., cable modem purposes. These IP paths will be connected to televisions as advanced digital settop boxes are deployed in the field.

Unfortunately, video quality will suffer where the decoder cannot decode the video stream in the processing time available. Past attempts to accommodate the need to decode streaming video in real-time have focussed, e.g., on modifying the decoder to handle the received data. See, e.g., M. Mattavelli and S. Brunetton, “Implementing Real-Time Video Decoding on Multimedia Processors by Complexity Prediction Techniques,” IEEE Transactions on Consumer Electronics, vol. 44, pp. 760-767, August 1998; and M. Mattavelli, S. Brunetton and D. Mlynek, “Computational Graceful Degradation for Video Sequence Decoding,” Proceedings IEEE Int. Conference Image Processing, vol. 1, pp. 330-333, October 1997, where the decoder is designed to estimate the decode time before decoding the bitstream and, based thereon, alters the way it proceeds with the actual decoding.

Other traditional approaches also focus only on optimizing the video decoder. Such approaches can be found, for example, in L. Chau, et al., “An MPEG-4 Real-Time Video Decoder Software,” Proceedings IEEE Int. Conference. Image Processing, vol. 1, pp. 249-253, October 1999; G. Hovden et al., “On Speed Optimization of MPEG-4 Decoder for Real-Time Multimedia Applications,” Proceedings IEEE Third Int. Conference. Computational Intelligence Multimedia Applications, pp. 399-402, September 1999; and F. Casalino, et. al., “MPEG-4 Video Decoder Optimization,” Proceedings IEEE Int. Conference Multimedia Computing Syst., vol. 1, pp. 363-368, June 1999.

Prior art techniques that address streaming video quality improvement from the decoder perspective have been less than satisfactory. Moreover, it is not desirable to modify thousands of existing decoders in order to accommodate streaming video, as the cost of such upgrades would be prohibitive.

Accordingly, it would be advantageous to provide techniques for improving streaming video quality, particularly for distribution over a cable or satellite television system, without requiring decoder modifications. It would be further advantageous to provide such techniques wherein the compression of digital video is improved for use by decoders, including software based decoders, that receive the compressed video. It would be still further advantageous to provide improved video quality to software decoders which have difficulty decoding in real-time due to limited processing capability.

The present invention provides video encoding apparatus and methods having the above and other advantages.

### SUMMARY OF THE INVENTION

Apparatus and methods are provided for improving video quality delivered to a display device. A current video signal segment is encoded for subsequent decoding at the display device. As part of the encoding step, an estimate is made of the time required for decoding the video signal segment at the display device. If the estimated time exceeds a predetermined decoder time period, either (i) the current video signal segment is re-encoded such that it can be decoded within the decoder time period, or (ii) a next video signal segment is encoded to enable decoding thereof without reference to the current segment. For purposes of the present disclosure, the “decoder time period” can comprise the time to decode one frame, part of a frame, or more than one frame. A longer decoder time period allows more sharing of the total time so that even if one frame exceeds its own frame decoder time period, the total time for a group of frames may not be exceeded.

In an illustrated embodiment, the estimating step models a decoder for the display device. The model preferably uses components of the decoder that are also present in an encoder used for the current video signal segment encoding step. The estimating step can use, for example, existing motion estimation information obtained during the encoding step.

Any one or more of various decoder functions can be modeled at the encoder. For example, the model can estimate a number of memory accesses required to decode the current video signal segment, can estimate a complexity of the current video signal segment, and/or can determine a number of compressed bits required by the current video signal segment. Alternatively, or in addition to the above, where the encoding step performs block transform coding, the model can monitor a number of blocks skipped during the block transform coding of the video signal segment. If the block transform coding provides different types of blocks, the model can monitor the number of different types of blocks provided during the block transform coding of the video signal segment.

The display device to which the encoded video is delivered can comprise, for example, a synchronous display device. The video signal segment can, e.g., be part of a streaming video data stream.

A storage medium encoded with machine-readable computer program code for performing the above method, as well as corresponding apparatus, is also disclosed. The apparatus comprises an encoder for encoding a current video signal segment to be decoded at the display device. The encoder is adapted to estimate a time required for decoding the video signal segment at the display device. If the estimated time exceeds a predetermined decoder time period, the encoder is used to encode one of (i) the current video signal segment such that it can be decoded within the decoder time period, or (ii) a next video signal segment to enable decoding thereof without reference to the current segment.

The encoder can be designed in a manner that always encodes the current video signal segment such that it can be decoded within the decoder time period. Alternatively, the encoder can be programmed such that if the estimated time exceeds the predetermined decoder time period, it will encode a next video signal segment to enable decoding thereof without reference to the current segment.

The encoder can be designed to model a decoder for the display device in order to estimate the decoding time. Preferably, the model will be implemented to use components of the decoder that are already present in the encoder. For example, the estimating step can be implemented to use existing motion estimation information obtained during said encoding step.

A system is disclosed for improving the display quality of a video signal. The system includes an encoder for encoding a video stream, a decoder for decoding the video stream for display on a display device, and a communication path for communicating the encoded video stream to the decoder. The encoder models the decoder to determine whether a time required for decoding a current segment of the video stream is likely to exceed a predetermined decoder time period allocated to the segment. If the time period is likely to be exceeded, the encoder will encode one of (i) the current video signal segment such that it can be decoded within said decoder time period, or (ii) a next video signal segment to enable decoding thereof without reference to the current segment. The communication path can comprise, for example, a streaming video server. At least a portion of the encoder can be contained in a transcoder for the video stream.

### BRIEF DESCRIPTION OF THE DRAWINGS

FIG. 1 is a block diagram of a video processing system in accordance with the present invention; and

FIG. 2 is a flow chart of an example decoder modeling algorithm in accordance with the invention.

### DETAILED DESCRIPTION OF THE INVENTION

The present invention provides methods and apparatus for improving the compression of video signals for streaming video applications. Video quality loss has been a problem for streaming video, particularly in the case where a video segment cannot be decoded in real-time on a personal computer. In such a situation, one or more video frames may be lost, leading to quality problems that are especially acute for subsequent predicted video frames that require the lost data in order to be properly reconstructed.

The techniques of the present invention differ from past attempts to solve the problems noted above by addressing video encoding not just from a video quality perspective, but also from a constrained decoding time point of view. In particular, the solution provided by the present invention estimates the decoding time using a model at the encoder. The encoder then adapts its coding strategy to optimize quality for a given decoding time constraint and platform. This is in contrast to the approaches taught by the prior art cited above where, e.g., the decoder estimates the decode time before decoding the bitstream and, based thereon, alters the way it proceeds with the actual decoding. Thus, whereas the prior art modifies the decoder in an effort to overcome decoder processing time constraints, the present invention focuses on modifying the encoder to provide a signal that the decoder will be able to properly decode in the time available. As such, the present invention provides more control over quality aspects, and does not require the decoder to be modified. This is particularly advantageous in that each encoder may provide signals to thousands of decoders, and it is preferable to undertake an encoder modification instead of modifying thousands of decoders in the field.

A suggestion of encoder modification can be found in K. Lengwehasatit and A. Ortega, “Distortion/Decoding Time Tradeoffs in Software DCT-Based Image Coding,” Proceedings IEEE Int. Conference. Acoustics Speech Signal Processing, pp. 2725-2728, 1997. This reference, however, only suggests making quantizer adjustments at the encoder, and it is proposed for image coding. Thus, it does not provide or suggest the present solution of estimating decode time at the encoder.

Typical compression schemes such as H.263+ and MPEG-4 have more computational complexity at the encoder than in the decoder. This makes it more difficult to run the encoder in real-time than to have the decoder run in real-time. A real-time encoder is necessary, however, for delivering live video events. Real-time encoding is not required for pre-recorded video programs where the compressed bitstream may be stored before being delivered. Typically, streaming video applications deliver pre-recorded video, so that real-time encoding is not necessary. In these cases, it is more important that the decoder run in real-time in order to provide a realistic viewing experience.

Depending on resources available, such as CPU (central processing unit) processing power and memory, a software decoder may not be able to run in real-time to decode conventional streaming video feeds. Moreover, since each video frame may require a different decode time, not all frames may be decoded in time for synchronous display. This can cause problems in predictive coding schemes, where frames are dependently coded based on previous frames. If the decoder cannot keep up with decoding a frame, the frame will not be ready when it is time to display that frame. Thus, the frame may be dropped, and subsequent dependent frames will be improperly decoded. As a consequence, video quality degrades until the next reference frame is successfully decoded.

In order to overcome this problem, the present invention, as noted above, estimates the decode time on the encoder side such that the encoder does not produce a bitstream which exceeds the decode time period. This requires the encoder to have some information about the decoder processing power. With such information, the encoder can generate bitstreams which are optimized for particular decoder platforms. If the encoder does not have to generate these bitstreams in real-time (i.e., the video can be stored for later playback), a variety of bitstreams can be encoded and stored for later delivery to a population of decoders with different capabilities. Decoders with higher processing power would generally receive improved video quality relative to those with lower processing power.

For decoders which have difficulty decoding bitstreams in real-time (e.g., synchronous display decoders), the encoder can modify its encoding strategy so that the decoder will be able to reconstruct the best possible video quality given the limited decoder resources. Using a model of the decoder, the encoder can estimate when the decoder may have difficulty decoding a bitstream (or a particular video segment thereof) in real-time. To estimate decoding time at the encoder, the model at the encoder (“encoder model”) can, for example, clock the decoding time of various components already present at the encoder which are equivalent to decoder elements. For example, it is typical that a video encoder and decoder will have corresponding motion compensation processing elements. The encoder model can also count or monitor parameters such as the number of compressed bits, memory accesses, skipped macroblocks, and the like in order to estimate decoding time for each frame. The encoder model can be quite simple, so as to minimize the computation required.

If the encoder estimates that the decoding time period will be exceeded for a given frame, it can alter its encoding strategy based upon whether the encoding is to be done in real-time or non-real time. For the non-real-time case, the encoder can make additional passes at encoding which may include skipping blocks, increasing quantization, dropping coefficients, restricting motion, and/or other optimization techniques. For the real-time case, if encoder processing time is available (or if, for example, multiple processors are used), the encoder can alter its encoding strategy the same way as in the non-real-time case. If encoder processing time is not available, the encoder can, e.g., encode the next frame (or the next soonest frame) as an Intracoded frame (I-Frame). As well known in the art of video compression, and particularly motion compensation, an I-frame is one that is complete in and of itself, and does not have to be predicted from a previous or future frame. Encoding the next (or next soonest) frame as an I-frame is analogous to the encoder detecting that the decoder will make an error in decoding. Accordingly, as an error recovery technique, the encoder encodes the next (or next soonest) frame as an I-frame to prevent error propagation into future frames.

It is noted that in cases where the encoder has the option of encoding the next (or next soonest) frame as an intra-frame (intracoded frame), the current frame should not be used as a reliable reference for prediction of any other frames, as the current frame will be improperly decoded. Therefore, it is only necessary to encode the next frame using intra-coding if the current frame is (or was) used as a reference for prediction. If, for example, the current frame was a B-frame (bi-directionally predicted frame) and it was not properly decoded, it is not necessary for the encoder to alter its strategy since the effect of improperly decoding the B-frame will presumably be limited to that frame only. This is because the B-frame is not used as a reference or “anchor” for any other frame.

In view of the above, if there are no B-frames, and, for example, the encoded sequence was I1, P2, P3, P4, P5, etc. (in display order), if P3 (a P-frame, or forward predicted frame) is not decoded properly, then frame four should be intra-coded to yield I1, P2, P3, I4, P5, etc. Otherwise, P4 would generally be predicted using erroneous data from P3.

On the other hand, if there are, for example, two B-frames, and if the encoded sequence was, e.g., I1, B2, B3, P4, B5, B6, P7, B8, B9, P10, etc. (in display order), if any of the B-frames will not be decoded within the decoder time period, the encoder need not necessarily alter its strategy. However, in the event that the encoded sequence was, e.g., I1, B2, B3, P4, B5, B6, P7, B8, B9, P10, etc. (in display order), and if P4 will not be decoded in time, then the encoder may alter its strategy to give I1, B2, B3, P4, I5, B6, B7, P8, B9, B10, etc., or alternatively I1, B2, B3, P4, I5, B6, P7, B8, B9, P10, etc. Alternatively, the encoder may alter its strategy to provide I1, B2, B3, P4, B5, B6, I7, B8, B9, P10, etc. In addition, if it is known at the encoder that P4 will be decoded in error, then it is possible to encode B2 and B3 using only forward prediction modes so as not to use any erroneous data from P4. There are many other possible strategies that the encoder may use, however, a given strategy may alter the GOP (group-of-pictures) structure for the affected GOP(s), which must be dealt with or avoided.

The main point is that the encoder need alter its strategy only if the current frame is used as a reference frame, and that the “next frame” may actually be the next frame in display order, or may be some other future encoded frame.

For cases where the decoder does not completely decode a given frame within the decode time period, this frame may be viewed (from the decoder's point of view) as a lost frame. In this sense, the techniques of the invention may be viewed as error resilience techniques. However, in contrast to traditional error protection schemes that add redundant bits, the approach of the invention may actually reduce the number of bits for a given frame. An optional “time control” mechanism can be incorporated into the encoder to supplement the traditional bit rate control mechanism. In this manner, any bits saved by the time control mechanism may be used by the bit rate control to improve the quality of other frames.

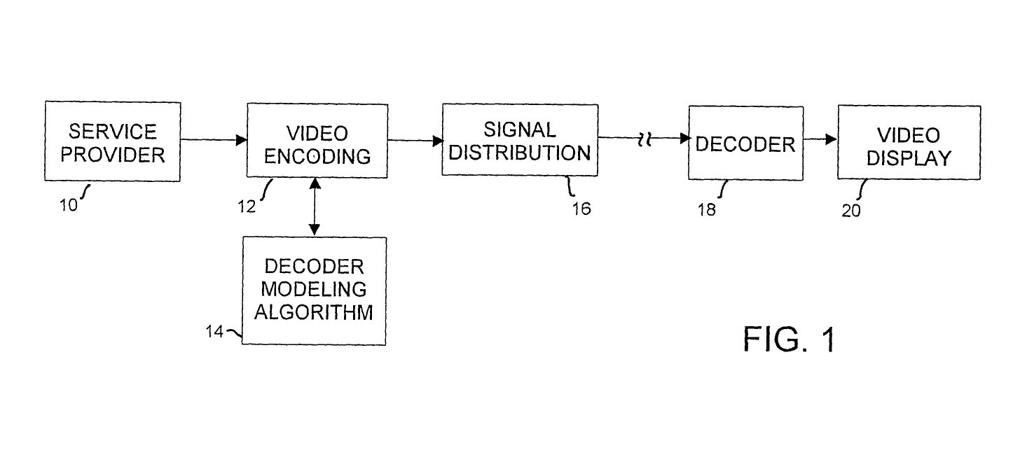

FIG. 1 illustrates the components of the invention in block diagram form. A service provider 10 provides video data (e.g., movies, television programs, special events, multimedia presentations, or the like) to a video encoder 12. The encoder 12 will encode the input video, e.g., by compressing it using conventional video compression techniques, such as motion compensation techniques. In accordance with the present invention, the encoder is provided with a decoder modeling algorithm 14, as described above. In particular, the algorithm 14 estimates, at the encoder, the time it will take a decoder to decode a particular video segment that has been encoded by the encoder. Such a segment can comprise, for example, a video frame or any other defined portion of the video data that is decoded during a “decode time” at the decoder.

If the estimate provided by algorithm 14 indicates that the encoded video segment can be decoded during the decode time, this segment is distributed via a signal distribution component 16 to a decoder 18. The signal is communicated in a conventional manner over a distribution path that can comprise any known video communication path, such as a broadband cable television network, a satellite television network telephone lines, wireless communication, or the like and may or may not include the Internet or other global, wide area, or local area network. Any of these communication paths can be used alone or combined to distribute the video signal to one or more decoders. Moreover, when the invention is used for streaming video, a streaming video server will be provided as part of the signal distribution component 16.

If the decoder modeling algorithm 14 determines that the encoded video segment cannot be properly decoded within the decode time, the segment can be reencoded (e.g., at a lower quality) such that it can be decoded within the decoder time period. Alternatively, a next video signal segment can be encoded to enable decoding thereof without reference to the current segment. In this manner, it is assumed that the current segment will not be properly decoded, but the next segment will be, so that damage to the overall video presentation is limited.

Once the decoder 18 receives the streaming video (with the encoded video segments) from the signal distribution path, the video is decoded and presented on a video display 20 in a conventional manner for viewing. As should be appreciated, the decoder does not have to modified in any way in accordance with the invention; only the encoder is modified to model the decoder and to take appropriate action based thereon.

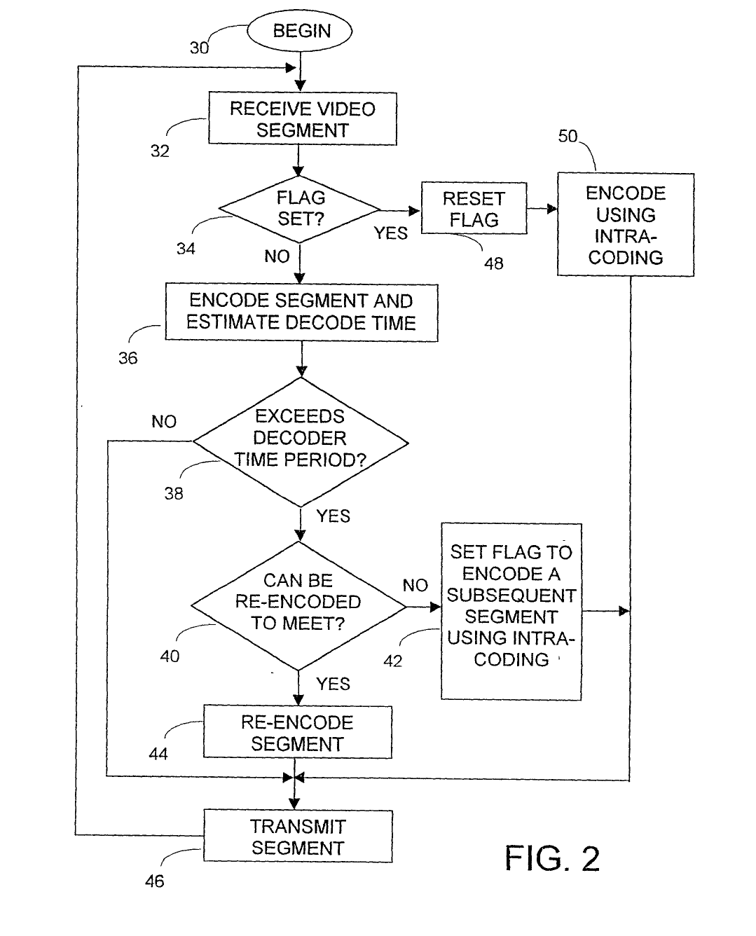

An example decoder modeling algorithm that can be used in accordance with the invention is illustrated in the flowchart of FIG. 2. It is noted that the algorithm of FIG. 2 is provided for purposes of illustration only, and that other implementations of the invention are possible.

The algorithm begins at box 30, and at box 32 a next video segment is received. A determination is then made (box 34) as to whether a flag was set during the processing of the previous segment, instructing the encoder to encode the present frame using intra-coding (e.g., as an I-frame). If so, the flag is reset at box 48, and the present frame is encoded using intra-coding and transmitted to the decoder (box 46). Otherwise, the present segment (e.g., video frame) is encoded and its decode time is estimated (box 36). If the estimated decode time exceeds the amount of time the decoder will have to decode the segment (the “decoder time period”), as determined at box 38, then a determination is made (box 40) as to whether the segment can be re-encoded by the encoder to meet the decoder time period. If not, the flag discussed in connection with box 34 is set so that the next segment (e.g., video frame) will be encoded using intra-coding. In the event that the estimated decode time does not exceed the decoder time period, the current segment is transmitted as is, as indicated at box 46.

If it is determined that the segment can be re-encoded for decoding within the decoder time period, the segment is re-encoded to achieve this result (box 44). Then, the re-encoded segment is transmitted to the decoder, as indicated at box 46. It should be noted that when real-time encoding is used, encoded bits for the segment must be output by a certain encode time. Thus, there may not be enough time to re-encode the segment. In this case, the re-encoding may have to be deferred to the next segment. Alternatively, where there is not enough time to re-encode a current segment, the flag can be set (box 42) so that a subsequent (e.g., the next or a later) segment will be encoded using intra-coding. After a segment is transmitted, the algorithm returns to box 32 where the next video segment is received for similar processing.

The present invention can also be extended to transcoding. In particular, the techniques of the invention are appropriate for transcoding for different decoding platforms even with the same bandwidth constraint (i.e., “time transcoding” as opposed to “bandwidth transcoding”). Such transcoding may generate, for example, an output bitstream of roughly the same length as the input bitstream, but the time to decode each frame may be different in the input and output bitstreams. Such transcoding may be implemented in a manner that does not need to alter the temporal or spatial resolution of the video signal. For example, decode time can be decreased by skipping blocks, changing compression modes (e.g., inter/intra frame or macroblock coding), and/or dropping coefficients. Such a transcoder can be used, e.g., to modify a video bitstream so that it can be decoded by a decoder with lower processing capability, while still maintaining the best video quality possible in view of the decoder capability.

It should now be appreciated that the present invention provides apparatus and methods for improving the quality of streaming video delivered to processor constrained synchronous display decoders or the like. A current video signal segment is encoded for subsequent decoding at the display device. As part of the encoding step, an estimate is made of the time required for decoding the video signal segment at the display device. If the estimated time exceeds a predetermined decoder time period, either (i) the current video signal segment is re-encoded such that it can be decoded within the decoder time period, or (ii) a next video signal segment is encoded to enable decoding thereof without reference to the current segment.

Although the invention has been described in connection with a specific embodiment thereof, it should be appreciated that various modifications and adaptations can be made thereto without departing from the scope of the invention, as set forth in the claims.

What is claimed is:

1. A method for improving video quality delivered to a display device, comprising:
encoding a current video signal segment to be decoded at the display device;
estimating, as part of said encoding step, a time required for decoding said video signal segment at the display device; and
if the estimated time exceeds a predetermined decoder time period, performing one of:
(a) re-encoding said current video signal segment such that it can be decoded within said decoder time period,
(b) encoding a subsequent video signal segment to enable decoding thereof without reference to said current segment.

2. The method of claim 1, wherein only step (a) is performed.

3. The method of claim 1, wherein only step (b) is performed.

4. The method of claim 1, wherein said estimating step models a decoder for said display device.

5. The method of claim 4, wherein said model uses components of said decoder that are also present in an encoder used for said current video signal segment encoding step.

6. The method of claim 5, wherein said estimating step uses existing motion estimation information obtained during said encoding step.

7. The method of claim 4, wherein said model estimates a number of memory accesses required to decode said current video signal segment.

8. The method of claim 4, wherein said model estimates a complexity of said current video signal segment.

9. The method of claim 4, wherein said model determines a number of compressed bits required by said current video signal segment.

10. The method of claim 4, wherein:
said encoding step performs block transform coding; and
said model monitors a number of blocks skipped during the block transform coding of said video signal segment.

11. The method of claim 4, wherein:
said encoding step performs block transform coding;
the block transform coding provides different types of blocks; and
said model monitors the number of different types of blocks provided during the block transform coding of said video signal segment.

12. The method of claim 1 wherein said display device is a synchronous display device.

13. The method of claim 1 wherein said video signal segment is part of a streaming video data stream.

14. A storage medium encoded with machine-readable computer program code for performing the method of claim 1.

15. Apparatus for improving video quality delivered to a display device, comprising:
an encoder for encoding a current video signal segment to be decoded at the display device,
said encoder being adapted to estimate a time required for decoding said video signal segment at the display device, and if the estimated time exceeds a predetermined decoder time period, encoding one of:
(a) said current video signal segment such that it can be decoded within said decoder time period,
(b) a subsequent video signal segment to enable decoding thereof without reference to said current segment.

16. Apparatus in accordance with claim 15, wherein said encoder always encodes said current video signal segment such that it can be decoded within said decoder time period.

17. Apparatus in accordance with claim 15, wherein if the estimated time exceeds said predetermined decoder time period, the encoder always encodes a subsequent video signal segment to enable decoding thereof without reference to said current segment.

18. Apparatus in accordance with claim 15, wherein said encoder models a decoder for said display device in order to estimate the decoding time.

19. Apparatus in accordance with claim 18, wherein said model uses components of said decoder that are also present in the encoder.

20. Apparatus in accordance with claim 19, wherein said estimating step uses existing motion estimation information obtained during said encoding step.

21. Apparatus in accordance with claim 18, wherein said model estimates a number of memory accesses required to decode said current video signal segment.

22. Apparatus in accordance with claim 18, wherein said model estimates a complexity of said current video signal segment.

23. Apparatus in accordance with claim 18, wherein said model determines a number of compressed bits required by said current video signal segment.

24. Apparatus in accordance with claim 18, wherein:
said encoder performs block transform coding; and
said model monitors a number of blocks skipped during the block transform coding of said video signal segment.

25. Apparatus in accordance with claim 18, wherein:
said encoder performs block transform coding;
the block transform coding provides different types of blocks; and
said model monitors the number of different types of blocks provided during the block transform coding of said video signal segment.

26. Apparatus in accordance with claim 15 wherein said display device is a synchronous display device.

27. A system for improving the display quality of a video signal, comprising:
an encoder for encoding a video stream;
a decoder for decoding said video stream for display on a display device; and
a communication path for communicating the encoded video stream to said decoder;
said encoder modeling said decoder to determine whether a time required for decoding a current segment of said video stream is likely to exceed a predetermined decoder time period allocated to said segment; wherein:
if said time period is likely to be exceeded, said encoder will encode one of:
(a) said current video signal segment such that it can be decoded within said decoder time period,
(b) a subsequent video signal segment to enable decoding thereof without reference to said current segment.

28. A system in accordance with claim 27 wherein said communication path comprises a streaming video server.

29. A system in accordance with claim 27 wherein at least a portion of said encoder is contained in a transcoder for said video stream.
